(19) United States
(12) Patent Application Publication
(10) Pub. No.: US 2018/0345429 A1
(43) Pub. Date: Dec. 6, 2018

(54) NEEDLE GRIPPER

(71) Applicant: Fredy DOLL, Achern (DE)

(72) Inventor: Fredy DOLL, Achern (DE)

(21) Appl. No.: 15/515,039

(22) PCT Filed: Sep. 2, 2015
(86) PCT No.: PCT/EP2015/070089

§ 371 Date: Mar. 28, 2017

(30) Foreign Application Priority Data
Sep. 29, 2014 (DE) 10 2014 219 719.8

(51) Int. Cl. B23Q 3/06; B29C 70/54

(52) U.S. Cl. CPC B23Q 3/06; B29C 70/54

(57) ABSTRACT

A needle gripper for handling workpieces with needle grippers. The needle grippers have a base and at least two gripping needles movable with respect to the base between a release position and a gripping position, a movable first gripping needle arranged in a first orientation and a second movable gripping needle arranged in a second orientation which is different from the first orientation. A needle guide device is attached to the base and has guide channels for guiding the gripping needles. The needle gripper includes a rinsing device having a feed channel for a rinsing fluid and leading to a guide channel. The needle guide device is associated with a heating device by which the guide channels are heated, thereby heating the gripping needles.

### FIELD OF APPLICATION AND PRIOR ART

The invention relates to a needle gripper for handling workpieces by means of gripper needles which for the purpose of gripping the workpiece intrude into the latter by way of a distal needle end. To this end, a needle gripper of the generic type is specified with a base and at least two gripper needles which in relation to the base are displaceable between a retracted releasing position and an exposed gripping position, wherein at least one first gripper needle is disposed and repositionable in a first alignment, and at least one second gripper needle is disposed and repositionable in a second alignment that deviates from the first alignment. The needles are collectively guided through a needle-guiding device that is provided on the base and has guide ducts for guiding the gripper needles.

A generic needle gripper is a gripping mechanism which, for example in the form of a single needle gripper, can be attached to a robotic arm in order for the latter to be able to transport workpieces. It is also possible for a plurality of needle grippers to be attached in a mutually fixed location on a frame or the like, so that this plurality of needle grippers can collectively grip a workpiece.

The characteristic gripping technique of a needle gripper provides that the needles intrude into the workpiece. On account of the gripper needles intruding in dissimilar directions it is prevented that the workpiece, when being lifted, can slide off the needle gripper along the gripper needles.

In the case of needle grippers of the generic type and of needle grippers according to the invention, actuators which in particular are pneumatically activated and which permit translatory repositioning of the gripper needles along the respective alignment of the latter are usually provided on the base. The needle gripper can thus be moved up to a workpiece for the latter to be subsequently gripped by transferring the dissimilarly aligned gripper needles to their respective gripping position.

The use of needle grippers is possible if and when the workpiece to be gripped does not have a vulnerable surface. Gripping textile formations in particular is thus a usual field of application of needle grippers of the generic type.

The invention in particular is based on a particular field of application, specifically the handling of semi-finished products for fiber-composite workpieces. Fiber-composite materials are usually composed of a fibrous structure, for example from glass or carbon, which is surrounded by a matrix providing retention and protection. The matrix is typically formed by a material that is thermally liquefied during the production process and which cures post cooling and then can assume its functions as a matrix.

It is desirable for semi-finished products from fibers and a matrix to be gripped by a needle gripper according to the invention without on account thereof damaging the workpiece or the needle gripper. In the case of the field of application mentioned above, it has been established that such damage can arise on sides of the workpiece when the comparatively cold needles intrude into the heated workpiece. Local cooling in the matrix material, and thereby solidification of the matrix material in these regions, arises. This leads to difficulties in the case of subsequent methods that impart shape to the semi-finished product. It has also been established that matrix material that cools on the needles or adheres thereto after completion of the handling procedure remains on the needle and together with the latter makes its way into the guide duct of the gripper needle. This can cause defects and require complete disassembly of the needle gripper for the purpose of cleaning.

### OBJECT AND ACHIEVEMENT

It is an object of the invention to primarily refine a needle gripper of the generic type with a view to the abovementioned disadvantages being prevented or alleviated. It is furthermore an object of the invention to correspondingly also provide matching methods.

According to a first variant of the invention, the object is achieved in that the needle gripper is specified with a rinsing device, wherein the rinsing device has at least one supply duct for rinsing liquid, said supply duct opening into at least one guide duct of the gripper needles.

According to the invention it is thus provided that the needle gripper per se is provided with a cleaning potential in the form of an integrated rinsing device which permits rinsing of the guide ducts of the gripper needles. Herein, it is understood to be characteristic of a rinsing device in this context that liquid ducts which permit the supply of rinsing liquid from the outside and enable the latter to be directed onward into the guide ducts are available.

The guide ducts, like the at least one supply duct, are preferably formed by blind bores or through-bores in a common metallic component which is a component of the needle-guiding device and contains the guide ducts for the gripper needles.

A rinsing-liquid connector which enables a line connection or a hose connection to a conveying installation for the rinsing liquid is preferably provided on the needle-guiding device. The liquid is supplied by way of this rinsing-liquid connector, the former then making its way via the at least one supply duct into the guide ducts.

A design that is simple in terms of construction can be achieved in that a plurality of guide ducts for a plurality of gripper needles, in particular of identical alignment, are fed by a common linear supply duct. The latter can in particular be perpendicular to the supply ducts. Since it is considered advantageous for a plurality of needles of identical alignment which are guided in mutually parallel guide ducts to be provided on the needle gripper, it is particularly advantageous for this plurality of guide ducts or even all guide ducts of identically aligned gripper needles to intersect the supply duct in such a manner that said guide ducts can be collectively fed. Depending on the specific alignment of the gripper needles, it can even be possible for the guide ducts of all gripper needles, even of those of dissimilar alignments, to be fed by way of only one supply duct. However, in most instances it is advantageous for a plurality of supply ducts, in particular two supply ducts, which are in particular preferably aligned so as to be mutually parallel and which each are provided for feeding guide ducts of guide needles of dissimilar alignments, to be provided.

In the event of a plurality of supply ducts being available, the latter are preferably connected so as to communicate with the same rinsing-liquid connector on the needle-guiding device.

The implementation of a second variant of the invention is expedient in particular in a refinement of the described needle gripper having a rinsing device, but in an individual case also in a needle gripper without a rinsing device. In the case of said second variant it is provided that the needle-guiding device is assigned a heating installation by means of which the guide ducts for guiding the gripper needles can be heated, so as to on account thereof indirectly heat the gripper needles.

This heating of the gripper needles alleviates the issue of local defects in the workpieces, as mentioned at the outset. The gripper needles do not mandatorily have to have a temperature that is identical to that of the workpiece. Since the semi-finished product to be handled in the case of the field of application mentioned at the outset usually has a temperature exceeding 200° C., it is however considered advantageous for the heating installation to be sufficiently dimensioned and to be disposed sufficiently close to the gripper needles so that the gripper needles in the case of a usual ambient temperature of 20° C. can be heated to at least 180° C. The bearing face, which in the intended manner bears on the workpiece and is penetrated by the guide ducts, should also preferably be heatable by the heating installation to 180° C.

Apart from heating the gripper needles for the purpose of preventing defects in the workpiece, this heating is also to be seen in the context of cleaning the gripper needles and the guide ducts by way of the abovementioned rinsing device. It has been established that it is significantly simpler to relieve by means of a rinsing device gripper needles of matrix material that are heated and thus have counteracted a solidification of the matrix material.

As has already been mentioned, heating the gripper needles according to the invention is performed by heating the needle-guiding device in which the guide ducts are provided. Since the gripper needles are usually guided with play in the guide ducts, physical contact between the gripper needles and the internal faces of the guide duct is not always guaranteed. However, it has been established that the thermal transfer in the case of the conventional loose fits that are chosen here is sufficiently high so as to cause an almost identical temperature of the internal faces of the guide duct and of the gripper needles. In order for the rest of the heat to be transported from the heating installation to the gripper needles with only a slight insulating effect, it is advantageous for the needle-guiding installation to have a metallic needle-guiding block which is penetrated by at least one guide duct for guiding a gripper needle and which furthermore has a clearance into which the heating installation is inserted.

Heating the needle-guiding installation to temperatures in the range of 180° C. and more has however proven to also not always be entirely free of issues. The commensurate heating of the base by virtue of longitudinal expansion can lead to defects. Moreover, electronic components that are optionally provided on the base can incur damage.

It is therefore proposed that the thermal transfer between the base and the needle-guiding installation is restricted by one or a plurality of the following measures. The same measures are also proposed for use between a needle carrier to which proximal needle ends that face away from the tip are fastened, on the one hand, and the base, on the other hand.

A first possibility provides for a thermal insulation layer or tier to be disposed between the needle-guiding installation or the needle carrier, respectively, on the one hand, and the base, on the other hand. This can be a ceramics component, for example, which is used here. It is likewise considered advantageous for the insulation to be achieved in that at least one bearing face on the needle-guiding installation, on the needle carrier, or on the insulation mentioned, that faces in the direction of the base, and/or corresponding bearing faces on the base, are not configured so as to be planar but are specified with preferably rectilinear bearing ribs and grooves which reduce the directly contacting faces. This effect can also be amplified in that two mutually contacting bearing regions each are provided with such bearing ribs/grooves that are placed so as to have a mutual angular offset. On account thereof, the total bearing face between the bearing regions can be significantly reduced with high stability, since direct bearing is provided only at the intersection points of the bearing ribs. It can be likewise advantageous for a shield panel, in particular a shield panel made from stainless steel, to be attached between the base, on the one hand, and the needle-guiding installation and/or the needle carriers, on the other hand, said shield panel being in particularly effective against thermal radiation.

To the extent that the desired temperature of the base cannot be maintained solely by such passive insulation means, in the case of a particularly preferred design embodiment a cooling installation which serves for active cooling of the base can also be provided. In particular, such a cooling installation as substantial features comprises at least one cooling duct that penetrates the base and a coolant inlet connector and a coolant outlet connector. The coolant per se is supplied to the needle gripper by an external conveying installation. The cooling ducts which act as heat exchangers permit heating of the coolant which then exits the base again at the coolant outlet connector.

It is advantageous for the base to be assigned a temperature sensor which can be provided directly on the base or can also be configured in the form of a spaced-apart pyrometer. On account thereof, the temperature of the base can be detected so as to on account thereof either be able to activate the cooling installation in a targeted manner, or else to potentially provide cooling phases in the production process.

In order for workpieces to be gripped, the needle gripper preferably is specified with a bearing face which is placed in the workpiece before the needles are displaced for gripping the workpiece. This bearing face is preferably part of the needle-guiding installation and particularly preferably part of the metallic needle-guiding block mentioned. Heating of the needle-guiding block in the case of the availability of a heating installation thus also leads to this bearing face being heated such that damage to the matrix material can also be avoided here.

Apart from the described needle gripper per se, the invention also relates to a handling device for handling in particular semi-finished composite products, said handling device having at least one needle gripper as described above having a rinsing device, and a conveying installation for conveying rinsing liquid, said conveying installation by way of a rinsing-liquid line being connected to the supply duct or the supply ducts for rinsing liquid. A handling device having a needle gripper with a cooling device of the above-described type is also within the scope of the invention, wherein apart from the at least one needle gripper a conveying installation for conveying coolant is provided, said conveying installation by way of a cooling-liquid line being connected to a cooling duct in the base of the needle gripper.

Such a handling device can comprise a plurality of needle grippers which are collectively attached to a support frame and are provided for collectively handling workpieces. In the case of a plurality of such needle grippers being available for acting collectively, it can be advantageous for only one conveying installation for conveying rinsing liquid or for only one conveying installation for conveying cooling liquid, respectively, to be provided, a plurality of needle grippers being supplied by means of said conveying installations.

Since retrofitting of existing systems which are not specified with a rinsing installation or a heating installation, respectively, can be too complex in individual cases, it is proposed as an alternative to use a set which comprises a usual needle gripper with or without a rinsing device of the type described above, and a cleaning installation for cleaning the gripper needles. This cleaning device herein is specified with a textile or non-woven type cleaning portion which is provided for partially submersing contaminated gripper needles. The cleaning device furthermore is specified with a transport or replacement mechanism by way of which the cleaning portion is automatically displaceable or replaceable.

The cleaning device thus serves the purpose of external cleaning. To this end, the needle gripper in the production process is repeatedly moved up to the cleaning installation so as to relieve the gripper needles of contaminants by submersing the gripper needles into the cleaning portion. In order for the cleaning portion per se not to be used in an increasingly contaminated state, the cleaning device comprises a mechanism which permits the replacement of the cleaning portion. It is particularly advantageous for the cleaning installation to be specified with a textile or non-woven type material which is initially disposed on a roller and in an automated manner is subjected to incremental indexing when a cleaning procedure is scheduled, such that a fresh or at least not yet too frequently used cleaning portion can be used at all times. On account thereof, a replacement of the respective used cleaning portion takes place.

The planar cleaning portion can moreover by utilized for cleaning the bearing face for the workpiece, in that the needle gripper by way of the bearing face is moved up to the cleaning portion and, bearing on the latter, is repositioned relative to said cleaning portion. In the case of a cleaning device having a cleaning portion that is indexable in an automated manner, the indexing of the cleaning portion can be advantageously used to this end.

The corresponding method therefor is likewise considered as being within the scope of the invention. Herein, the needle gripper, coupled to a robotic arm, for example, moves up to the cleaning portion and then moves the gripper needles so as to let the latter be submerged preferably multiple times in the cleaning portion and to thereby wipe off the contaminants.

### BRIEF DESCRIPTION OF THE DRAWINGS

Further aspects and advantages of the invention are derived from the claims and from the following description of preferred exemplary embodiments of the invention that will be explained hereunder by means of the figures. In the figures:

FIGS. 1 and 2 show a needle gripper according to the invention in perspective from obliquely above;

FIGS. 3a and 3b show the needle gripper in a perspective from below, having retracted or deployed needles, respectively;

FIG. 4 shows an exploded illustration of the needle gripper;

FIGS. 5a and 5b show a needle-guiding block of the needle gripper in an external illustration and in an illustration with indicated ducts;

FIGS. 6a and 6b show sectional illustrations through the needle-guiding block of the needle gripper;

FIG. 7 shows a main body of the base of the needle gripper;

FIG. 8 shows a composite of a plurality of needle-guiding grippers having supply installations for rinsing liquid and cooling liquid; and

FIG. 9 shows a needle gripper having an external cleaning installation provided for the former.

### DETAILED DESCRIPTION OF THE EXEMPLARY EMBODIMENTS

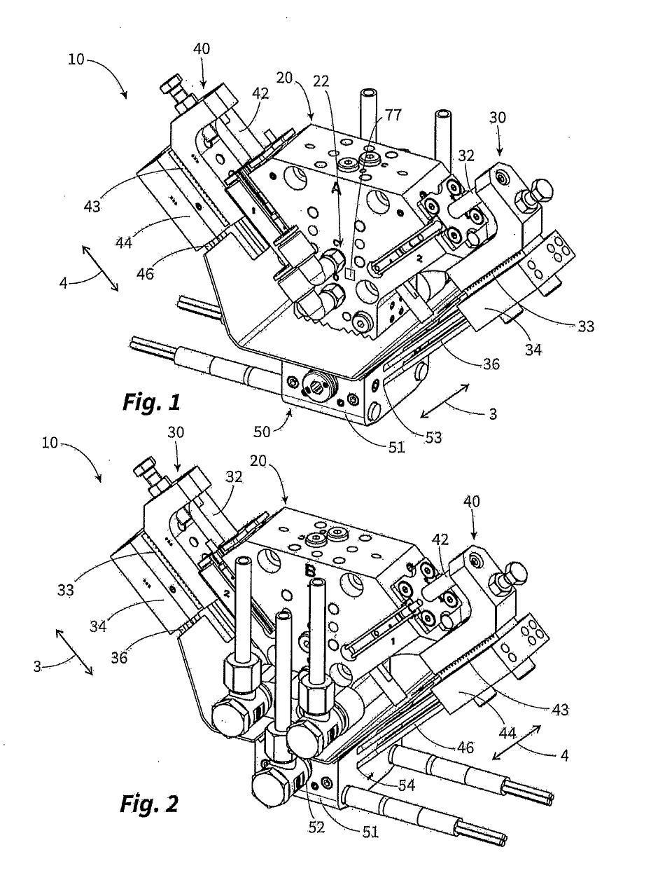

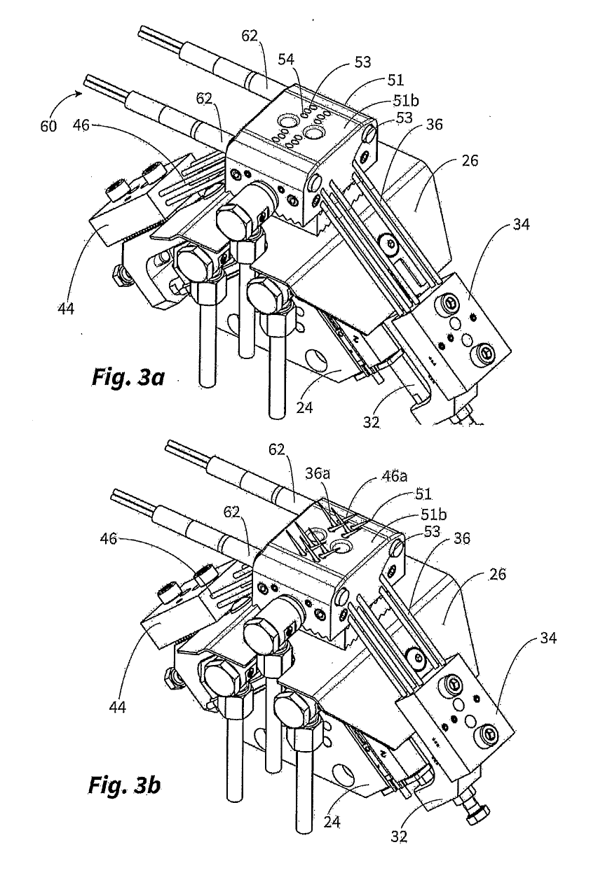

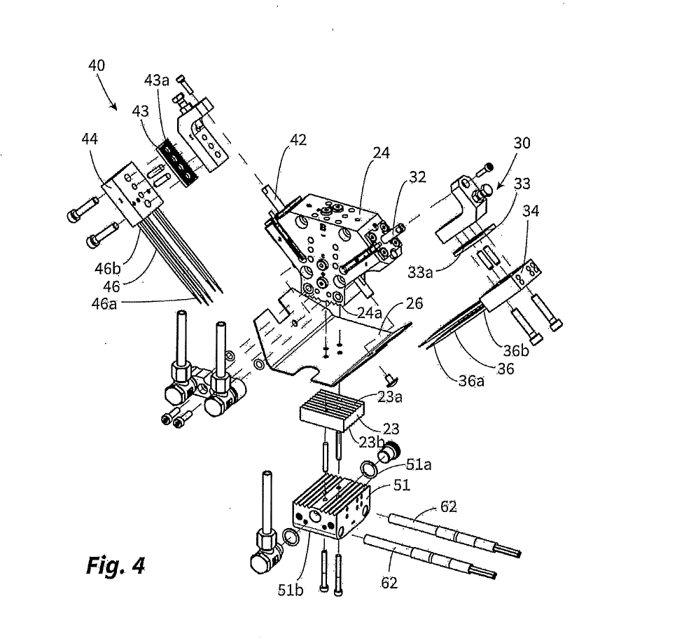

FIGS. 1 and 2 show a potential design embodiment of a needle gripper according to the invention. The substantial components are to be explained initially by means of these figures and of the exploded illustration of FIG. 4.

The needle gripper 10 is specified with a base 20 which is provided for attachment to a robotic arm or for collective attachment with further needle grippers to a common frame. Connectors 22 for pneumatic lines by means of which two pistons 32, 42 can be displaced in a translatory manner in the direction of the arrows 3, 4 are provided on the base 20.

Slides 30, 40 are displaceable in a translatory manner in the direction of the arrows 3, 4 by way of these pistons 32, 42. These slides each comprise one needle carrier 34, 44 to which the gripper needles 36, 46 of the needle gripper 10, by way of the proximal ends 36b, 46b of the former, are fastened. The distal ends 36a, 46a of the gripper needles 36, 46 protrude into guide ducts 53, 54 of a needle-guiding block 51 which is a major component part of a needle-guiding device 50.

Referring to FIGS. 3a and 3b, the needle gripper by way of a pneumatic movement of the slides 30, 40 thus allows the gripper needles 36, 46 to be transferred from their respective retracted state of FIG. 3a to their deployed state of FIG. 3b. The gripper needles 36, 46 can be transferred from the state of FIG. 3a in which the gripper needles 36, 46 do not protrude beyond a bearing face 51b of the needle-guiding block 51 to the deployed position of FIG. 3b in which said gripper needles 36, 46 in the respective dissimilar alignments thereof intrude into the workpiece and thus acquire the latter.

The needle gripper 10 illustrated has a number of particularities which relate to the field of application that is particularly envisaged for the former. This field of application is the handling of semi-finished products for fiber-composite material workpieces. These semi-finished products are composed of a fibrous structure and of a matrix material which is heated and not yet cured. Handling these mat-type semi-finished products is problematic when using traditional needle grippers, since the comparatively cool needles solidify the matrix material during transportation and moreover are thereby heavily contaminated.

In order to be utilized together with such semi-finished products and in comparable fields of application, the needle gripper 10 is specified with the following features:

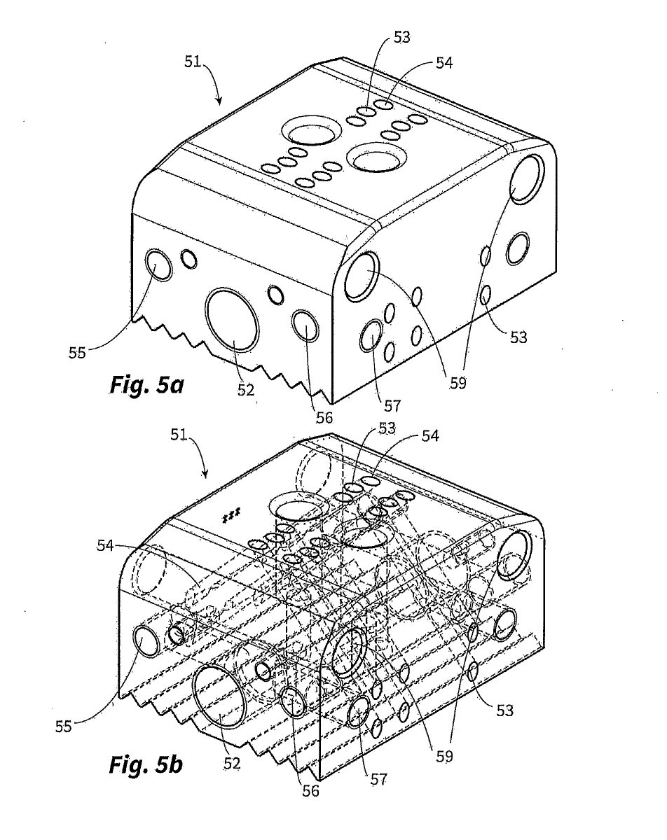

The needle gripper 10 is specified with an integrated rinsing device. This rinsing device comprises a rinsing-liquid connector 52 and supply ducts that are provided in the needle-guiding block 51. Referring to FIGS. 5a and 5b which show the needle-guiding block 51, two mutually parallel supply ducts 55, 56 which at the end side are closed by plugs, collectively with a distribution duct 57 that is aligned so as to be transverse to the former, and with the aforementioned rinsing-liquid connector 52 form the substantial components of the rinsing device. The two parallel supply ducts 55, 56 intersect the in each case six guide ducts 53, 54 of the gripper needles 36, 46 which each have a congruent alignment. The rinsing liquid by way of a rinsing-liquid conveying installation that is connected to the rinsing-liquid connector 52 can thus be conveyed up to the guide ducts 53, 54. Here, said rinsing liquid is forcibly squeezed into a narrow intermediate space between the gripper needles 36, 46 and the respective internal walls of the guide ducts 53, 54. Said rinsing liquid then flows from there along the guide ducts 53, 54 up to the respective ends of the latter, where said rinsing liquid exits.

By means of the rinsing device it is thus possible for residue in the guide ducts 53, 54 to be removed and for the gripper needles 36, 46 to be simultaneously cleaned. Such a cleaning procedure preferably takes place between transportation procedures. The gripper needles 36, 46 during cleaning can be moved in relation to the guide ducts 53, 54 so as to yet improve the cleaning effect.

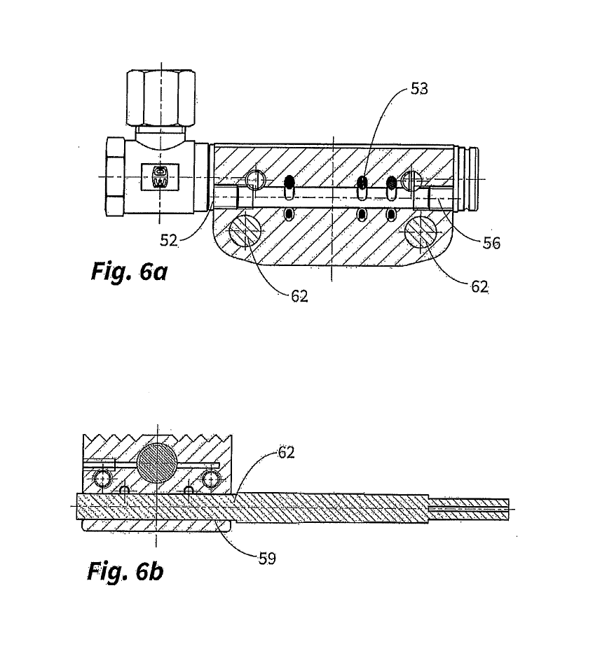

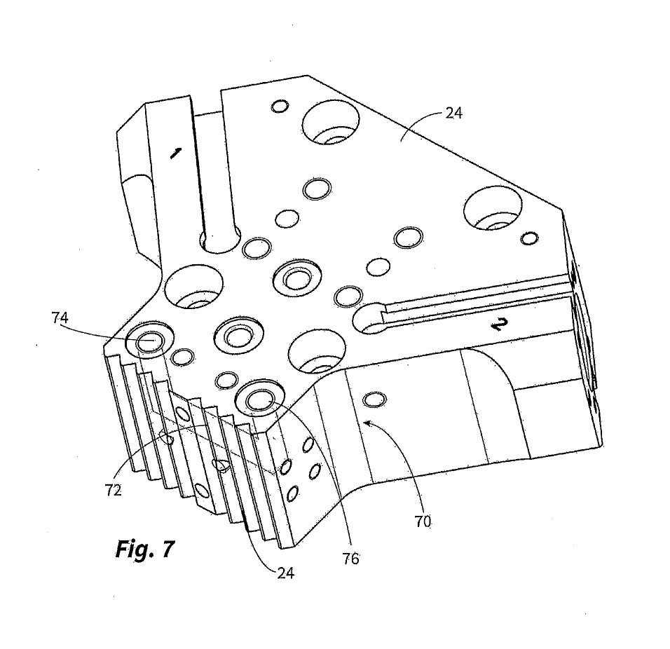

Moreover, the availability of a heating installation 60 is part of the specific particularities of the needle gripper illustrated here. This heating installation is composed of two heating rods 62 which are inserted into bores 59 of the needle-guiding block 51. This electric heating installation 60 is capable of heating the needle-guiding block 51 and thus the guide ducts 53, 54 that are provided in the latter. On account thereof, the needles 36, 46 are also heated. The heating installation which is schematically illustrated in the sectional illustrations of FIG. 6b allows the gripper needles 36, 46 to be heated to at least 180° C. Local cooling of the semi-finished product during transportation is effectively avoided by heating the needles to this temperature or to even higher temperatures. The heating installation can be activated permanently or be activated in phases, optionally also in response to a temperature that has been measured by a temperature sensor. Heating rods in which a thermostat has already been installed, such that the latter maintains a predefined temperature, can also be used.

Heating the needle-guiding block 51 and the guide ducts 53, 54 and the gripper needles 36, 46 serves not only for avoiding damage to the semi-finished products but also aids in cleaning the needle gripper by means of rinsing. The matrix material which continues to adhere to the gripper needles 36, 46 and possibly makes its way into the guide ducts 53, 54, by virtue of the high temperature solidifies to a lesser extent such that the removal of the said matrix material is correspondingly facilitated.

Heating of the needle-guiding block 51 can also lead to the base 20 of the needle gripper being heated, the latter not being desirable. Various measures are provided in order for this heating to be minimized.

It can be derived in particular from FIG. 4 that an insulation body 23 is provided between a main block 24 of the base 20 and the needle-guiding block 51. Said insulation body 23 can be composed of a ceramics material, for example. Said insulation body 23 impedes the thermal transfer from the heated needle-guiding block 51 to the main body 24. This effect is further supported in that the insulator 23 in two mutually opposite bearing regions 23a, 23b is in each case provided with alternating ribs and grooves in order for the effective bearing face to the neighboring functional groups to be reduced. In a similar manner, the bearing face 51a of the needle-guiding block 51 is also provided with alternating grooves and ribs. The thermal transfer from the needle-guiding block 51 to the insulator 23 by virtue of the offset disposition arises only in very small planar regions.

A similar mechanism is provided on the slides 30, 40. The needle carriers 34, 44 that are provided here for holding the needles are in relation to the pistons 32, 42 likewise insulated by thermally effective insulation bodies 33, 43 which in the region of a bearing face 43a, 33a likewise have alternating ribs and grooves in order for the bearing face that is effective in the thermal transfer to be reduced.

In order for the thermal input into the basic body 24 to be further reduced, a shield panel 26 that is made from stainless steel and is disposed between the needle-guiding block 51 and the basic body 24 is provided. Said shield panel 26 serves in particular for shielding the base body 24 from thermal radiation.

The passive measures described for preventing the thermal transfer from the needle-guiding block 51 to the basic body 24 can already be sufficient in an individual case. However, it can be advantageous for a cooling installation for active cooling to be additionally provided in the basic body 24. This cooling installation is composed of a coolant inlet connector 74, of a coolant outlet connector 76, and of cooling ducts 72 that penetrate the basic body 24 and as heat exchangers are suitable for releasing the heat of the heated basic body 24 to the cooling liquid and, on account thereof, to transport said heat away.

A temperature sensor 77 which detects whether active cooling is already required and allows active cooling to be initiated only in this case can moreover be part of the cooling installation.

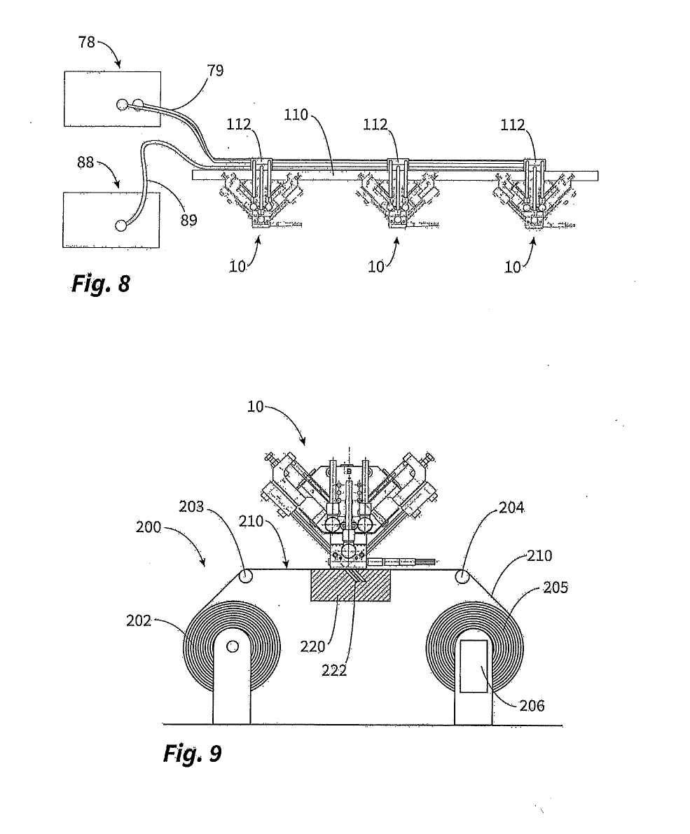

FIG. 8 shows the use of a needle gripper 10 described in conjunction with further needle grippers. The three needle grippers 10 in the example are collectively attached to a frame 110 and are thus in each case conjointly moved. This frame 110 is provided with distributors 112 for rinsing liquid and cooling liquid. A conveying installation 88 for the rinsing liquid, which by way of a line 89 is connected to the frame 110 and to the distributors 112 therein, is furthermore provided. A further conveying installation 78 which by way of lines 79 is connected in a similar manner to the frame 110, to the distributors 112 and thus to the needle grippers 10 is provided for the cooling liquid.

FIG. 9 shows a set composed of a needle gripper 10 which in a manner deviating from the needle gripper illustrated could also be configured without a dedicated rinsing installation, since an additional external cleaning installation 200 is provided. This external cleaning installation is specified with a source roll 202 from a planar textile or non-woven type material that by way deflection rollers 203, 204 is guided to a target roll 205. The target roll 205 is assigned a motor 206 by way of which the material web 210 of the textile or non-woven type material can be unwound from the roll 202 and be wound onto the roll 205.

The textile or non-woven type material web 210 represents a cleaning means by means of which the gripper needles 36, 46 can be cleaned. The needle gripper 10 can be moved up to the material web 210 in the manner illustrated in FIG. 9, and then pierce the latter by moving the needles through the material web 210, wherein residues are wiped off the gripper needles. In order for this procedure to be facilitated, a support block 220 is disposed below the material web 210 in the case of the exemplary embodiment illustrated, one or a plurality of clearances 222 into which the needles can be driven being provided in said support block 220.

When interacting with a conventional needle gripper, the cleaning device 200 allows the specific contaminants which arise when semi-finished composite products are transported to be removed without having to utilize a special needle gripper for this purpose.

The cleaning device 200 can moreover also be utilized for cleaning the bearing face 51b in that the bearing face 51b that in the case of retracted needles bears on the material web 210 is repositioned relative to the material web 210. This can be performed by a movement of the needle gripper. However, this is preferably performed in the case of a stationary needle gripper, by way of the movement of the material web 210 that is driven by the motor 206.

1. A needle gripper for handling workpieces by means of gripper needles which for the purpose of gripping the workpiece intrude into the latter by way of a distal needle end, said needle gripper having
a base, and
at least two gripper needles which in relation to the base are displaceable between a releasing position and a gripping position, wherein at least one first gripper needle is disposed and repositionable in a first alignment, and at least one second gripper needle is disposed and repositionable in a second alignment that deviates from the first alignment,
wherein
at least one needle-guiding device has guide ducts for guiding the gripper needles and is attached to the base, and
the needle gripper is specified with a rinsing device, wherein the rinsing device has at least one supply duct for rinsing liquid, said supply duct opening into at least one guide duct.

2. The needle gripper as claimed in claim 1, wherein the needle-guiding device has a plurality of guide ducts for a plurality of gripper needles, wherein a common linear supply duct opens into this plurality of guide ducts, wherein these guide ducts are provided for guiding gripper needles of identical alignment.

3. The needle gripper as claimed in claim 1, wherein the needle-guiding device has a plurality of supply ducts which each open into at least one guide duct for a gripper needle, wherein these guide ducts are provided for guiding gripper needles of dissimilar alignments, and wherein the plurality of supply ducts are connected to a common rinsing-liquid connector on the needle-guiding device.

4. The needle gripper as claimed in claim 1, wherein the needle-guiding device is assigned a heating installation by means of which guide ducts for guiding the gripper needles are heatable, so as to be able to heat the gripper needles.

5. The needle gripper as claimed in claim 4, wherein the needle-guiding device has a metallic needle-guiding block which is penetrated by at least one guide duct for guiding a gripper needle, wherein the needle-guiding block furthermore has at least one clearance into which the heating installation is inserted.

6. The needle gripper as claimed in claim 4, wherein between the base and the needle-guiding device and/or a needle carrier to which a proximal needle end of at least one gripper needle is fastened are provided:
a thermal insulation layer, and/or
a bearing region which for the purpose of thermal insulation is provided with bearing ribs, and/or
a shield panel for shielding thermal radiation.

7. The needle gripper as claimed in claim 4, wherein the base is assigned a cooling installation.

8. The needle gripper as claimed in claim 7, wherein the cooling installation is specified with cooling ducts and a coolant inlet connector and a coolant outlet connector.

9. The needle gripper as claimed in claim 4, wherein the base is assigned a temperature sensor.

10. The needle gripper as claimed in claim 1, wherein the needle gripper has a bearing face for bearing on the workpiece, wherein this bearing face is part of the needle-guiding installation, and is formed by a surface of the needle-guiding block.

11. A handling device for handling a semi-finished composite product comprising a fibrous structure and a matrix, wherein the handling device comprises:
at least one needle gripper for handling workpieces by means of gripper needles which for the purpose of gripping the workpiece intrude into the latter by way of a distal needle end, said needle gripper having a base, and
at least two gripper needles which in relation to the base are displaceable between a releasing position and a gripping position, wherein at least one first gripper needle is disposed and repositionable in a first alignment, and at least one second gripper needle is disposed and repositionable in a second alignment that deviates from the first alignment, wherein
at least one needle-guiding device has guide ducts for guiding the gripper needles and is attached to the base, and
the needle gripper is specified with a rinsing device, wherein the rinsing device has at least one supply duct for rinsing liquid, said supply duct opening into at least one guide duct, and
a conveying installation for conveying rinsing liquid, said conveying installation by way of a rinsing-liquid line being connected to the supply duct for rinsing liquid, or
the handling device comprises:
at least one needle gripper for handling workpieces by means of gripper needles which for the purpose of gripping the workpiece intrude into the latter by way of a distal needle end, said needle gripper having a base, and
at least two gripper needles which in relation to the base are displaceable between a releasing position and a gripping position, wherein at least one first gripper needle is disposed and repositionable in a first alignment, and at least one second gripper needle is disposed and repositionable in a second alignment that deviates from the first alignment, wherein
at least one needle-guiding device has guide ducts for guiding the gripper needles and is attached to the base, and
the needle gripper is specified with a rinsing device, wherein the rinsing device has at least one supply duct for rinsing liquid, said supply duct opening into at least one guide duct, wherein the base is assigned a cooling installation, and
a conveying installation for conveying cooling liquid, said conveying installation by way of a cooling-liquid line being connected to a cooling duct in the base.

12. A method for handling a semi-finished composite product comprising a fibrous structure and a matrix, wherein handling is performed by means of at least one needle gripper as claimed in claim 1.

13. A set composed of:
a needle gripper for handling workpieces by means of gripper needles which for the purpose of gripping the workpiece intrude into the latter by way of a distal needle end, said needle gripper having
a base, and
at least two gripper needles which in relation to the base are displaceable between a releasing position and a gripping position, wherein at least one first gripper needle is disposed and repositionable in a first alignment, and at least one second gripper needle is disposed and repositionable in a second alignment that deviates from the first alignment,
and
a cleaning installation for cleaning the gripper needles, wherein the cleaning device has a textile or non-woven type cleaning portion which is provided for partially submersing contaminated gripper needles, wherein the cleaning device is specified with a transport or replacement mechanism by way of which the cleaning portion is automatically displaceable or replaceable.

14. A method for cleaning a needle gripper having gripper needles which in relation to a base of the needle gripper are displaceable for gripping workpieces, wherein:
a. the needle gripper moves up to a textile or non-woven type cleaning portion, and
b. the gripper needles are displaced in relation to the base so as to on account thereof intrude into the cleaning portion.

15. The method as claimed in claim 14, wherein the cleaning portion is replaced, preferably in an automated manner, between two mutually sequential cleaning procedures.
